(19) United States
(12) Patent Application Publication
(10) Pub. No.: US 2011/0156874 A1
(43) Pub. Date: Jun. 30, 2011

(54) RFID Tags, RFIG Transmission Methods And RFID Devices

(75) Inventors: Hsin-Chin LIU, Taipei City (TW); Wang-Chi LIN, Taipei City (TW)

(73) Assignee: NATIONAL TAIWAN UNIVERSITY OF SCIENCE & TECHNOLOGY, Taipei City (TW)

(21) Appl. No.: 12/834,586

(22) Filed: Jul. 12, 2010

(30) Foreign Application Priority Data
Dec. 29, 2009 (TW) 098145471

(51) Int. Cl. H04Q 5/22

(52) U.S. Cl. 340/10.1

(57) ABSTRACT

A radio frequency identification tag for multi-path transmission is provided, including: a plurality of antennas, receiving a wireless signal transmitted by a reader and generating an antenna signal, respectively, and backscattering an encoded and modulated backscatter signal to the reader, in which the polarizations of the plurality of antennas are different; a demodulator, demodulating the antenna signal, to generate a plurality of demodulated signals corresponding to the antenna signal; a signal processor, selecting one of the plurality of demodulated signals or combining the plurality of demodulated signals for processing according to characteristics of the plurality of the demodulated signals to read data and generating a backscatter signal; and a space-time code encode and modulator, encoding and modulating the backscatter signal according to a space-time code to generate the encoded and modulated backscatter signal.

### CROSS REFERENCE TO RELATED APPLICATIONS

This application claims priority of Taiwan Patent Application No. 098145471 filed on Dec. 29, 2009, the entirety of which is incorporated by reference herein.

### BACKGROUND OF THE INVENTION

1. Technical Field

The invention relates to tags with a plurality of antennas, and more particularly, to radio frequency identification systems and methods preventing multi-path interference.

2. Related Art

Radio frequency identification is a non-contact automatic identification technique, which can effectively reduce manpower and man-made errors. A radio frequency identification system is composed of host computers, tags, and readers, wherein the tags identify wireless radio frequency signals transmitted by the readers at a distance, and transmit stored information therein back to the readers.

In order to meet various demands, radio frequency identification tags are classified to the three types: passive tags, semi-passive tags and active tags. The required power for the passive tags is provided by continuous radio frequency waves transmitted from the readers, and its backscatter signal is generated by modulate impinging continuous radio frequency waves. The required power of the semi-passive tags is provided by batteries and the method to backscatter signals is the same as that of the passive tags. The required power of the active tags is provided by batteries and the method to backscatter signals uses a circuit to generate radio frequency signals to transmit the signals back to the readers instead of backscatter. The active tags are analogous to general two-way radio frequency communication devices.

However, in wireless and mobile communication systems, wireless radio wave signals between transmitters and receivers are reflected and hindered by a surrounding environment. Therefore, signals which come from different paths reach the receivers and interfere with each other such that the amplitude and phase of the received signals change and the strength of the signals decrease, decreasing the quality of communications. This phenomenon is called multi-path fading. The conventional tags have only one antenna each. Thus, readers may not be able to properly identify tags, which reduce reliability of the system, when the signal power received by the tags affected by multi-path fading is lower than the power threshold which is required by the readers.

Therefore, for radio frequency identification systems, it is important to decrease the effect of multi-path fading on system performance.

### BRIEF SUMMARY OF THE INVENTION

One aspect of the invention is to provide a radio frequency identification tag for multi-path transmission, comprising: a plurality of antennas for receiving a wireless signal transmitted by a reader and generating an antenna signal, respectively, and backscattering an encoded and modulated backscatter signal to the reader, in which the polarizations of the plurality of antennas are different; a demodulator for demodulating the antenna signal, to generate a plurality of demodulated signals corresponding to the antenna signal; a signal processor for selecting one of the plurality of demodulated signals or combining the plurality of demodulated signals for processing according to characteristics of the plurality of the demodulated signals to mad data and generating a backscatter signal; and a space-time code encoding modulator for encoding and modulating the backscatter signal according to a space-time code to generate the encoded and modulated backscatter signal.

Another aspect of the invention is to provide a radio frequency identification transmission method used for a radio frequency identification system, comprising: receiving a wireless signal transmitted by a reader by a plurality of antennas and generating an antenna signal, respectively, in which the polarizations of the plurality of antennas are different; demodulating the antenna signal, respectively, to generate a plurality of demodulated signals corresponding to the antenna signal; selecting one of the plurality of demodulated signals or combining the plurality of demodulated signals for processing according to characteristics of the plurality of the demodulated signals to read data, and generating a backscatter signal; and encoding and modulating the backscatter signal according to a space-time code to generate the encoded and modulated backscatter signal; and backscattering the encoded and modulated backscatter signal to the reader, respectively, by the plurality of antennas.

Another aspect of the invention is to provide a reader for transmitting a wireless signal to the radio frequency identification tag mentioned above. The reader comprises a read antenna, receiving the encoded and modulated backscatter signal transmitted, respectively, by the plurality of antennas; a channel estimator, estimating a plurality of channel information according to the encoded and modulated backscatter signal; and a maximum ratio combining device, processing the encoded and modulated backscatter signal according to the encoded and modulated backscatter signal and the plurality of channel information.

The advantage and spirit of the invention may be better understood by the following recitations and the appended drawings.

### BRIEF DESCRIPTION OF DRAWINGS

The invention can be more fully understood by reading the subsequent detailed description and examples with references made to the accompanying drawings, wherein:

FIG. 1 is a block diagram illustrating a radio frequency identification tag 10 for effectively resisting multi-path interference in a multi-path transmission according to an embodiment of the invention.

FIG. 2 is a flow chart illustrating a radio frequency identification transmission method 20 used for a radio frequency identification system which comprises a reader and a radio frequency identification tag according to an embodiment of the invention.

FIG. 3 is a block diagram illustrating a radio frequency identification system 3 according to an embodiment of the invention, wherein the radio frequency identification system 3 comprises a reader 30 and a radio frequency identification tag 31.

FIGS. 4-1 and 4-2 are examples illustrating the space-time block code according to an embodiment of the invention.

FIG. 5 illustrates an instant checking table composed of sub-tables 5-1˜5-4 according to an embodiment of the invention.

FIG. 6-1 illustrates a backscatter signal constellation example according to an embodiment of the invention.

FIG. 6-2 is a table illustrating the transmitted backscatter signals corresponding to the sub-tables 5-1˜5-4 according to an embodiment of the invention.

FIG. 7 illustrates another instant checking table composed of sub-tables 7-1˜7-4 according to an embodiment of the invention.

FIG. 8 is a table illustrating the transmitted backscatter signals corresponding to the sub-tables 7-1˜7-4 according to an embodiment of the invention.

### DETAILED DESCRIPTION

The following description may be a contemplated mode of carrying out the invention. This description is made for the purpose of illustrating the general principles of the invention and should not be taken in a limiting sense. The scope of the invention is best determined by reference to the appended claims.

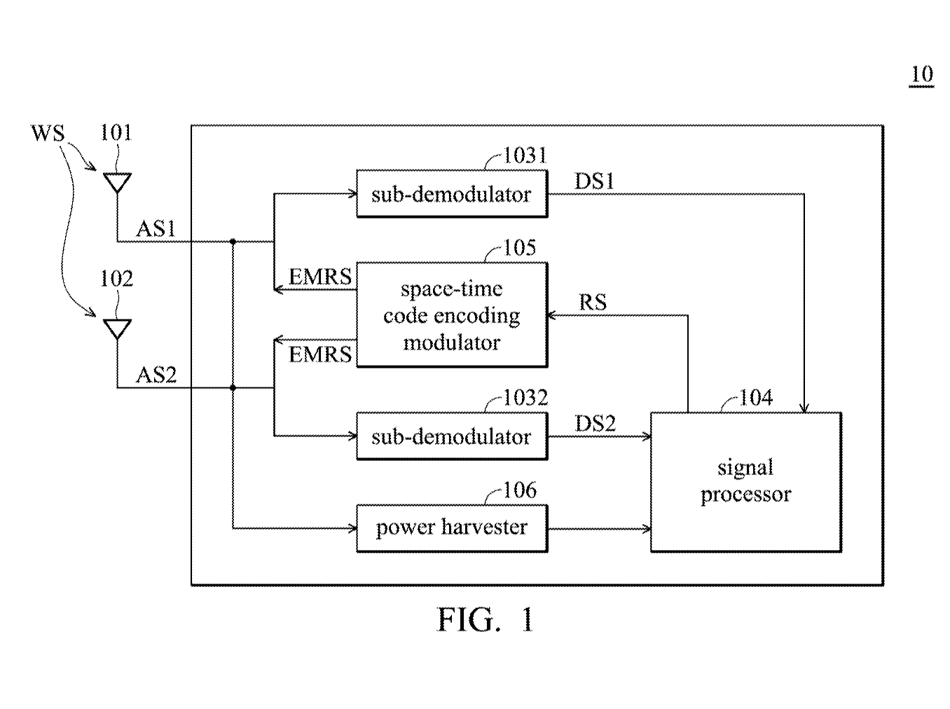

FIG. 1 is a block diagram illustrating a radio frequency identification tag 10 for effectively resisting multi-path interference in a multi-path transmission according to an embodiment of the invention. The radio frequency identification tag 10 comprises a first antenna 101 and a second antenna 102 (the invention is not limited to two antennas), a demodulator (1031 and 1032), a signal processor 104 and a space-time code encoding modulator 105.

The first antenna 101 and the second antenna 102 receive a wireless signal WS transmitted by a reader and generate a first antenna signal AS1 and a second antenna signal AS2, respectively, and are also configured to transmit (i.e., backscatter) an encoded and modulated backscatter signal EMRS back to the reader, wherein the polarizations of the first antenna 101 and the second antenna 102 are mutually orthogonal, but it is not limited thereto. For example, the first antenna 101 is a horizontal polarized antenna and the second antenna 102 is a vertical polarized antenna. In some embodiments, polarizations of the antennas in the radio frequency identification tag 10 can also be not mutually orthogonal but different.

A demodulator comprises a first sub-demodulator 1031 and a second sub-demodulator 1032, and the first sub-demodulator 1031 and the second sub-demodulator 1032 demodulate the first antenna signal AS1 and the second antenna signal AS2, respectively, to generate the first demodulated signal DS1 corresponding to the first antenna signal AS1 and the second demodulated signal DS2 corresponding to the second antenna signal AS2. In other words, the first sub-demodulator 1031 and the second sub-demodulator 1032 down-convert the first antenna signal AS1 and the second antenna signal AS2 to baseband signals, respectively, and convert the analog signals into digital signals.

A signal processor 104 selects one of the plurality of demodulated signals for processing according to the received signal power or the received signal quality of the first demodulated signal DS1 and the second demodulated signal DS2 to read data, and generates a backscatter signal RS.

For example, the signal processor 104 first selects the processing of signals based on the first demodulated signal DS1 to read data in the first demodulated signal DS1, when the signal processor 104 determines that the signal quality of the first demodulated signal DS1 is better than the second demodulated signal DS2, or the signal power of the first demodulated signal DS1 is larger than the second demodulated signal DS2. However, the invention is not limited to the characteristics of the demodulated signals such as signal power or signal quality. At a future time, the signal processor 104 selects the processing of signals based on the second demodulated signal DS2 to read data in the second demodulated signal DS2, when the signal processor 104 determines that the signal quality of the first demodulated signal DS1 is worse than the second demodulated signal DS2, or the signal power of the first demodulated signal DS1 is smaller than the second demodulated signal DS2.

A space-time code encoding modulator 105 is configured for encoding and modulating the backscatter signal RS by backscatter according to a space-time black code (STBC) or a space-time trellis code (STTC) to generate the encoded and modulated backscatter signal EMRS. Next, the encoded and modulated backscatter signal EMRS is transmitted (i.e., backscattered) to the reader, respectively, by the first antenna 101 and the second antenna 102, to effectively reduce the multi-path interference which the multi-path transmission causes according to the space-time black code (STBC) or the space-time trellis code (STTC).

When the radio frequency identification tag 10 is a passive tag or a semi-passive tag, the radio frequency identification tag 10 further comprises a power harvester 106. The power harvester 106 may rectify, boost and regulate continuous wave signals the signal processor 104 process and read data. The radio frequency identification tag 10 comprises a battery (not shown in the FIG. 1) to provide power to the signal processor 104, when the radio frequency identification tag 10 is an active tag.

Therefore, the radio frequency identification tag 10 can be one of a passive tag, a semi-passive tag and an active tag. However, the exemplary embodiment in the invention is based on the semi-passive tag and the space-time code encoding modulator 105 encodes and modulates the backscatter signal RS according to the space-time black code (STBC).

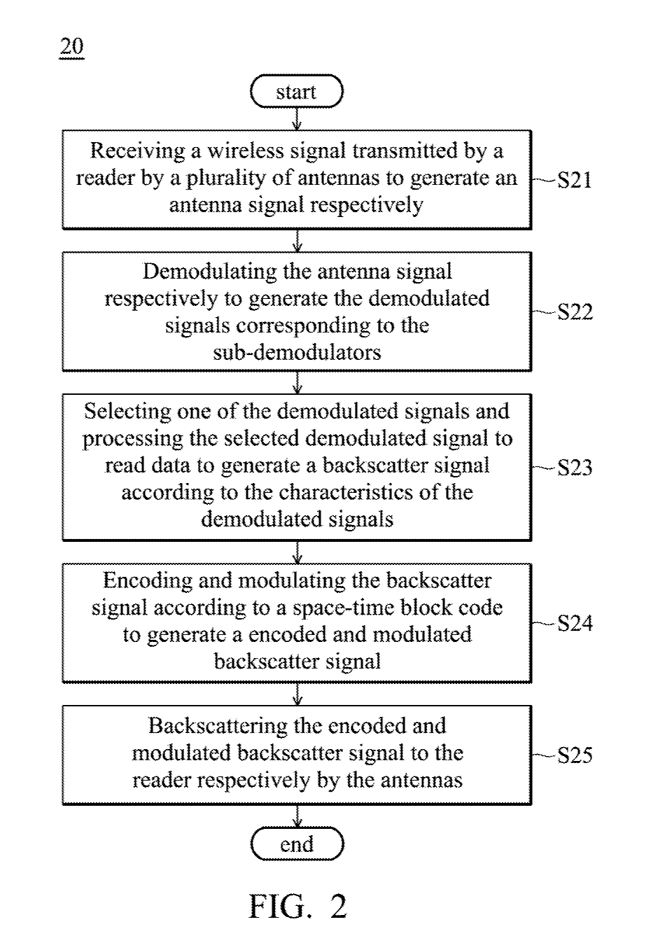

FIG. 2 is a flow chart illustrating a radio frequency identification transmission method 20 used for a radio frequency identification system which comprises a reader and a radio frequency identification tag according to an embodiment of the invention. The radio frequency identification transmission method 20 comprises receiving a wireless signal transmitted by a reader by a plurality of antennas and generating an antenna signal, respectively, in which the polarizations of the plurality of antennas are mutually orthogonal (step S21). For example, of the two antennas, one is a horizontal polarized antenna and the other is a vertical polarized antenna, such that the polarizations between them are mutually orthogonal such as the first antenna 101 and the second antenna 102 as shown in the FIG. 1. In some embodiments, polarizations of the antennas in the radio frequency identification tag 10 can also be not mutually orthogonal but different.

The radio frequency identification transmission method 20 further comprises demodulating the antenna signal, respectively by the first sub-demodulator 1031 and the second sub-demodulator 1032, to generate a plurality of demodulated signals, respectively corresponding to the antenna signal such that there are demodulated signals (step S22).

The radio frequency identification transmission method 20 further comprises in step S23, selecting one of the demodulated signals, demodulated by the first sub-demodulator 1031 and demodulated by the second sub-demodulator 1032 or combining the demodulated signal demodulated by the first sub-demodulator 1031 and the demodulated signal demodulated by the second sub-demodulator 1032 according to characteristics of the plurality of the demodulated signals such as signal power and signal quality of the received demodulated signals, and processing signals in the signal processor 104 to read data and generate a backscatter signal.

The radio frequency identification transmission method 20 further comprises in step S24, encoding and modulating the backscatter signal according to a space-time block code to generate the encoded and modulated backscatter signal, and in step S25, backscattering the encoded and modulated backscatter signal to the reader, respectively, by the plurality of antennas.

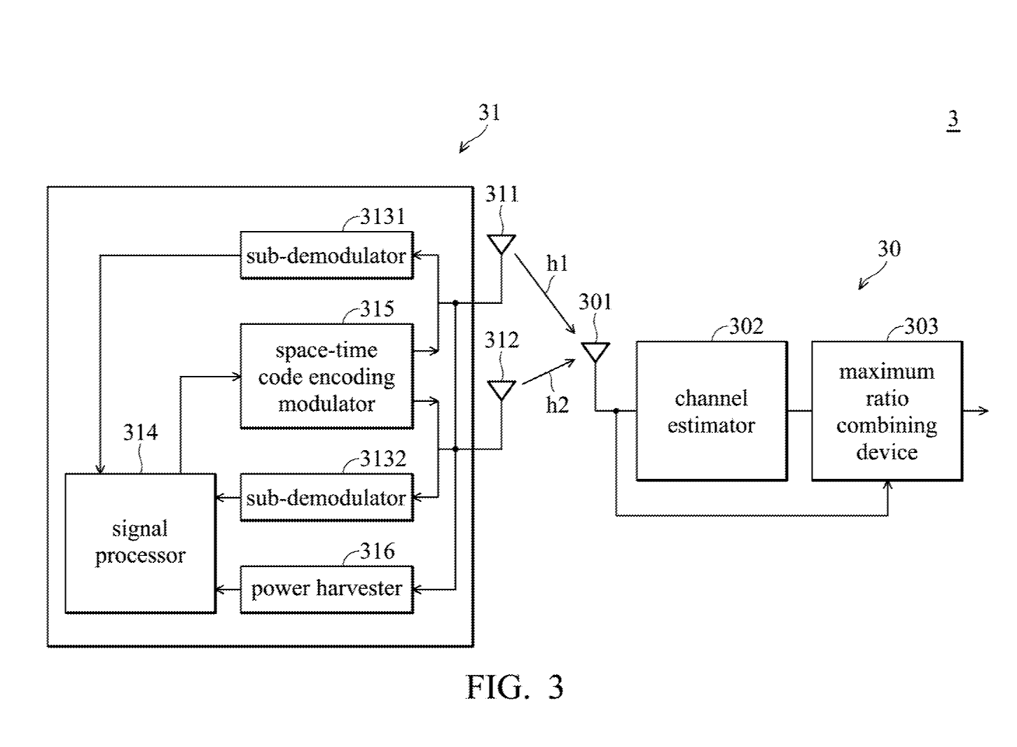

FIG. 3 is a block diagram illustrating a radio frequency identification system 3 according to an embodiment of the invention, wherein the radio frequency identification system 3 comprises a reader 30 and a radio frequency identification tag 31. In forward link (the reader 30→ the radio frequency identification tag 31), first the reader 30 transmits a wireless signal WS to the radio frequency identification tag 31. A plurality of antennas in the radio frequency identification tag 31 (first antenna 311 and second antenna 312) receive the wireless signal, respectively, and generates a first antenna signal AS1 and a second antenna signal AS2, respectively, in which the polarizations of the first antenna 311 and the second antenna 312 are mutually orthogonal. In some embodiments, polarizations of the antennas in the radio frequency identification tag 10 can also be not mutually orthogonal but different. A first sub-demodulator 3131 and second sub-demodulator 3132 in a demodulator demodulates the first antenna signal AS1 and the second antenna signal AS2, respectively, to generate a plurality of demodulated signals DS1 and DS2 corresponding to the antenna signals. A signal processor 314 in the radio frequency identification tag 31 selects one of the demodulated signals DS1 and DS2 according to characteristics of the demodulated signals DS1 and DS2 to read data in the wireless signal WS transmitted by the reader 30.

Furthermore, in reverse link (the radio frequency identification tag 31→ the reader 30), a signal processor 314 in the radio frequency identification tag 31 reads data in the wireless signal WS transmitted by the reader 30 and then responds to the read data to generate a backscatter signal RS. A space-time code encoding modulator 315 encodes and modulates the backscatter signal RS according to a space-time block code to generate the encoded and modulated backscatter signal EMRS, wherein multi-path interference in a multi-path transmission from the radio frequency identification tag 31 to the reader 30 can be reduced by the space-time block code. A first antenna 311 and a second antenna 312 transmit (i.e, backscatter) the encoded and modulated backscatter signal EMRS, respectively, to the reader 30. Note that the power harvester 306 in FIG. 3 and the power harvester 106 in FIG. 1 have the same function.

The reader 30 comprises a read antenna 301, a channel estimator 302 and a maximum ratio combining device 303, but the invention is not limited thereto, in which the antenna 301 is arranged to transmit and receive radio wave. The read antenna 301 receives the encoded and modulated backscatter signal EMRS, respectively transmitted (i.e., backscattered) by the first antenna 311 and a second antenna 312 in the radio frequency identification tag 31. The channel estimator 302 estimates a plurality of channel information to obtain the estimated channel response according to the encoded and modulated backscatter signal EMRS. The maximum ratio combining device 303 processes the encoded and modulated backscatter signal EMRS according to the encoded and modulated backscatter signal EMRS and the plurality of channel information by a maximum likelihood estimation algorithm to accurately decode the signals backscattered by the radio frequency identification tag 31.

FIGS. 4-1 and 4-2 are examples illustrating the space-time block code according to an embodiment of the invention. The two symbols, s1 and s2, are coded by the space-time block code and two antennas (first and second antennas). The coding method of the space-time block code is described below. First, at time “t”, the first antenna transmits (i.e., backscatters) the signal “s1” and at the same time (at time “t”) the second antenna transmits (i.e., backscatters) the signal “s2*”, wherein “*” represents complex conjugate. At time “t+T” (T represents a symbol time), the first antenna transmits (i.e., backscatters) the signal “s1” and at the same time (at time “t+T”) the second antenna transmits (i.e., backscatters) the signal “−s1*”.

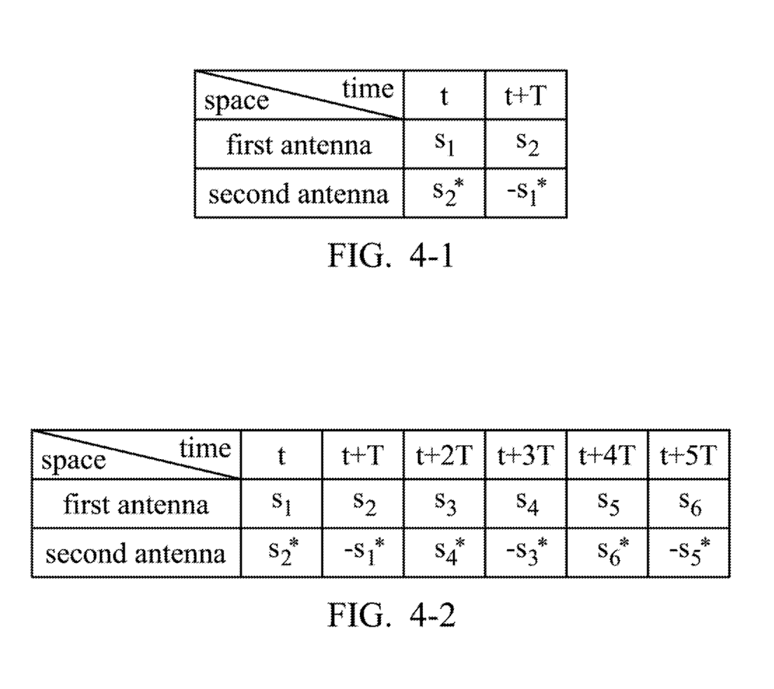

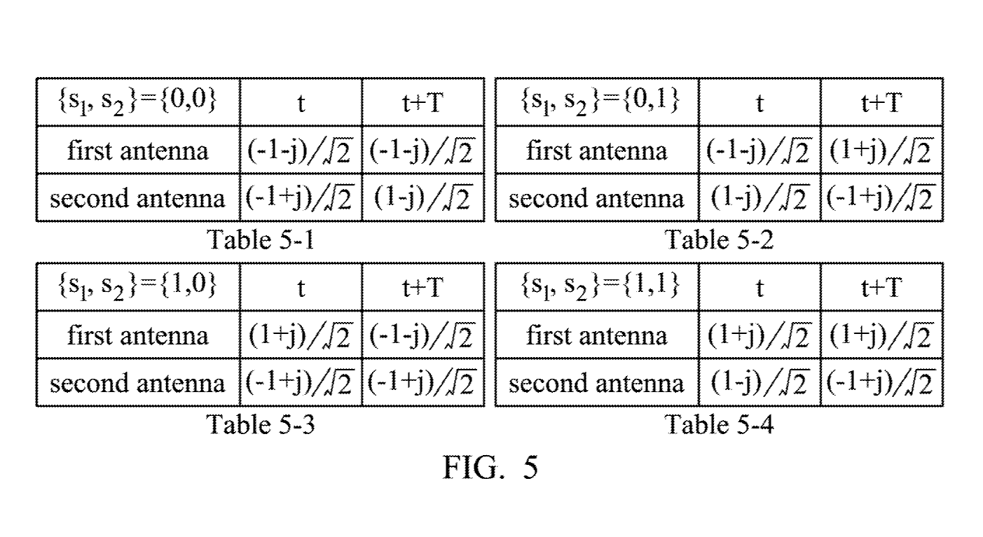

For example, a sequence of symbols, “s2”, “s2”, “s3”, “s4”, “s5” and “s6”, are transmitted by the space-time block code and the two antennas (first and second antennas). The transmission method is shown in the FIG. 4-2. At time “t”, the first antenna transmits the signal “s1” and the second antenna transmits the signal “s2*”. At time “t+T” (T represents a symbol time), the first antenna transmits the signal “s2” and the second antenna transmits the signal “−s1*”. At time “t+2T”, the first antenna then transmits the signal “s3” and the second antenna transmits the signal “s4*” and at time “t+3T” the first antenna transmits the signal “s4” and the second antenna transmits the signal “−s3*”. At time t+4T″, the first antenna then transmits the signal “s5” and the second antenna transmits the signal “s6*” and at time “t+5T” the first antenna transmits the signal “s6” and the second antenna transmits the signal “−s5*”. FIG. 5 illustrates an instant checking table composed of sub-tables 5-1˜5-4 according to an embodiment of the invention. When the wanted transmitted symbols {s1,s2} is {0,0},{0,1}, {1,0} or {1,1}, the signals wanted to be transmitted by antennas are checked instantly according to the sub-tables 5-1˜5-4 in the FIG. 5.

Take FIG. 3 for example, the radio frequency identification tag 31 transmits the two symbols, “s1” and “s2”, to the reader 30 by the first antenna 311 and the second antenna 312. At time “t”, the reader 30 receives the symbol “s1” through a first channel and the symbol “s2” through a second channel, wherein the response of the first channel is represented by “h1” and the response of the second channel is represented by “h2”. Therefore, at time “t” the reader 30 receives a signal “n”, wherein r1=r(t)=h1·s1+h2·(s2*)+n1 (equation (1)), the number “n1” represents Gaussian white noise at time “t”, the symbol “•” represents multiplication and “s2*” is a complex conjugate number of “s2”.

At time “t+T”, the reader 30 receives the symbol “s2” though the first channel and the symbol “−s1*” though the second channel. Therefore, at time “t+T” the reader 30 receives a signal “r2”, wherein r2=r(t+T)=h1·s2+h2·(−s1*)+n2 (equation (2)), the number “n2” represents Gaussian white noise at time “t+T”, the symbol “•” represents multiplication and “s1*” is a complex conjugate number of “s1”.

At first, the channel estimator 302 in the reader 30 estimates the response of the first channel “h1” and the response of the second channel “h2” and then the maximum ratio combining device 303 in the reader 30 combines and processes the signals “r(t)” and “r(t+T)” and also uses the channel responds “h1” and “h2” estimated by the channel estimator 302 to estimate signals “s1” and “s2” transmitted by the radio frequency identification tag 31 by the maximum likelihood estimation algorithm, wherein the parameters ŝ₁ and ŝ₂ represent the estimated signals “s1” and “s2” by the reader 30.

Therefore the equation (3) is obtained and shown below according to the combination and processing of the equation (1) and the equation (2). The equation (3) is:

ŝ₁=h₁*r₁−h₂r₂*

ŝ₁h₂r₁*+h₁*r₂ equation (3)

The equation (1) and the equation (2) may be applied to the equation (3) to obtain an equation (4), and the equation (4) is:

ŝ₁=(|h₁|²+|h₂|²)s₁h₁*n₁−h₂n₂*

ŝ₁=(|h₁|²+|h₂|²)s₂h₁*n₂−h₂n₁* equation (4)

The effect of the path-path interference generated by the path-path transmission may be beneficially converted by the coding method of the space-time block code according to the equation (4). Therefore, the problem of the path-path interference generated by path-path transmission can be effectively mitigated.

In addition, the passive tags or semi-passive tags generate backscatter signals by backscatter. Therefore, the backscatter plays a very important role in a radio frequency identification system. The relationship between the total scattering field Ēₜ (Z_{L}), antenna resistance Zₐ and RFID chip load Z_{L} is described as equation (5). The equation (5) is:

Ēt(Z_{L}*)=Ēs(Zₐ*)−Γ(Z_{L})Is(Zₐ*)Ēᵣ equation (5)

wherein:

Ēₛ(Zₐ*) is Scattering field when the antenna resistance and the RFID chip load are a complex conjugate matching each other;

Is(Zₐ*) is a terminal current when the antenna resistance and the RFID chip load are a complex conjugate matching each other;

Ēᵣ is radiated field under the tag antenna current unit;

Γ(Z_{L}) is voltage reflection coefficient when the RFID chip load equals Z_{L}, wherein the relationship between the voltage reflection coefficient Γ(Z_{L}), the antenna resistance Zₐ and the RFID chip load Z_{L} is described as: Γ(Z_{L})=Z_{L}−Zₐ*/a+Zₐ (equation (6)).

The semi-passive RFID tags with two antennas fabricate and generate all kinds of wanted backscatter signals according to the equation (6). Therefore, in one example, the first antenna only transmits two kinds of signals,

$$\frac{1 + j}{\sqrt{2}} or \frac{- 1 - j}{\sqrt{2}}$$

according to the sub-tables 5-1˜5-4 in the FIG. 5, such that the space-time code encoding modulator 315 only generates two phases, in which the phase difference between them is 180 degrees, and the load Z_{1,A1} of the backscatter signal S_{1,A1} (corresponding to the signal

$$\frac{1 + j}{\sqrt{2}} )$$

and the load Z_{2,A1} of the backscatter signal S_{2,A1} (corresponding to the signal

$$\frac{- 1 - j}{\sqrt{2}} )$$

are the same. Furthermore, the second antenna only transmits two kinds of signal,

$$\frac{1 - j}{\sqrt{2}} or \frac{- 1 + j}{\sqrt{2}}$$

such that the space-time code encoding modulator 315 only generates two phases, in which the phase difference between them is 180 degrees, and the load Z_{1,A2} of the backscatter signal S_{1,A2} (corresponding to the signal

$$\frac{1 - j}{\sqrt{2}} )$$

and the load Z_{2,A2} of the backscatter signal S_{2,A2} (corresponding to the signal

$$\frac{- 1 + j}{\sqrt{2}} )$$

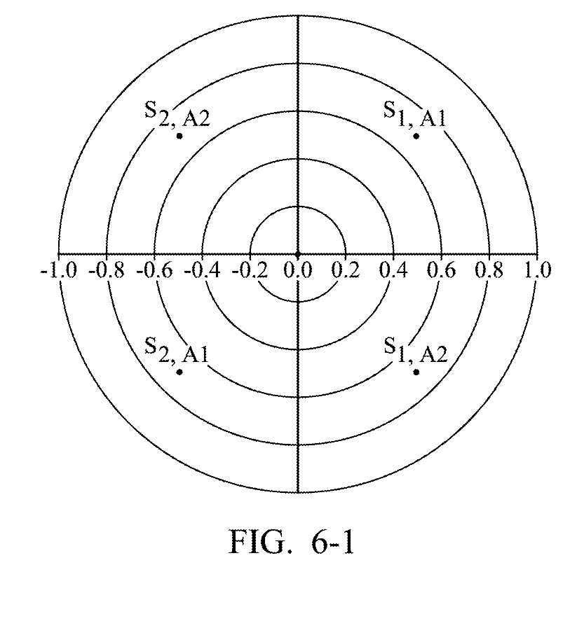

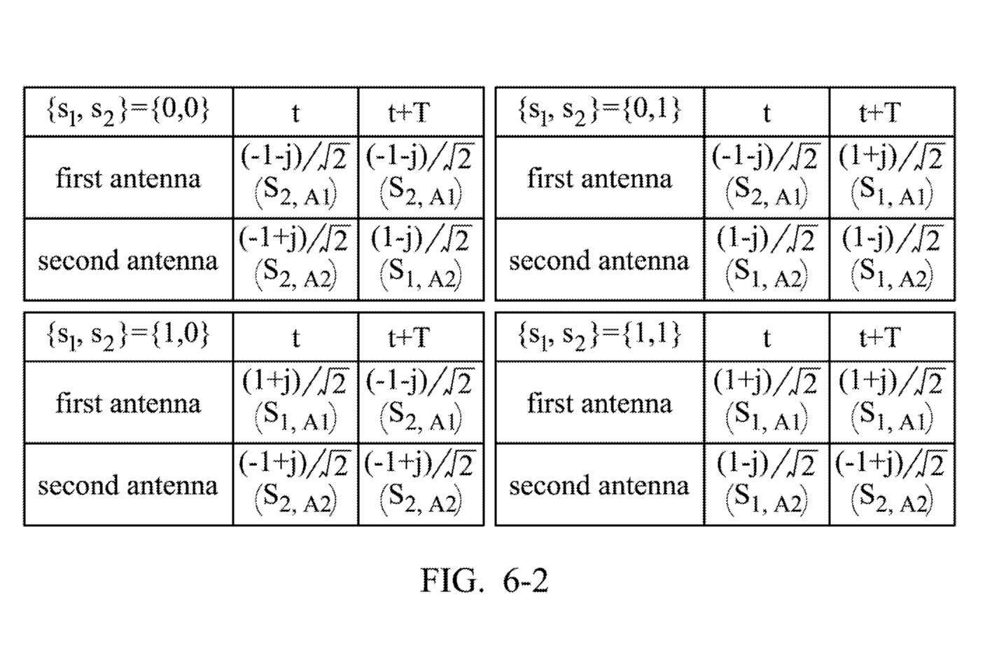

are the same. Therefore, FIG. 6-1 illustrates a backscatter signal constellation example according to an embodiment of the invention and FIG. 6-2 is a table illustrating the transmitted backscatter signals corresponding to the sub-tables 5-1˜5-4 according to an embodiment of the invention.

Therefore, the space-time code encoding modulator 315 only controls the first antenna to switch between the load Z_{1,A1} and the load Z_{2,A1} and the second antenna to switch between the load Z_{1,A2} and the load Z_{2,A2} according to the description above. For example, the space-time code encoding modulator 315 controls the first antenna to switch to the load Z_{1,A1} when the first antenna wants to transmit the signal

$$\frac{1 + j}{\sqrt{2}} ,$$

and then the signal is immediately sent by the first antenna is

$$\frac{1 + j}{\sqrt{2}} .$$

Furthermore, the space-time code encoding modulator 315 controls the first antenna to switch to the load Z_{2,A1} when the first antenna wants to transmit the signal

$$\frac{- 1 - j}{\sqrt{2}} ,$$

and then the signal is immediately sent by the first antenna is

$$\frac{- 1 - j}{\sqrt{2}} .$$

In addition, the space-time code encoding modulator 315 controls the second antenna to switch to the load Z_{1,A2} when the second antenna wants to transmit the signal

$$\frac{1 - j}{\sqrt{2}} ,$$

and then the signal is immediately sent by the second antenna is

$$\frac{1 - j}{\sqrt{2}} .$$

Furthermore, the space-time code encoding modulator 315 controls the second antenna to switch to the load Z_{2,A2} when the second antenna wants to transmit the signal

$$\frac{- 1 + j}{\sqrt{2}} ,$$

and then the signal is immediately sent by the second antenna is

$$\frac{- 1 + j}{\sqrt{2}} .$$

The method described above effectively simplifies the encoding and modulating technique of the space-time code encoding modulator 315 and only controls the load of antennas to simply transmit the encoded and modulated backscatter signals to the reader 30. Thus, hardware of the space-time code encoding modulator 315 is simplified, and a simple scheme is used to encode and modulate the backscatter signals.

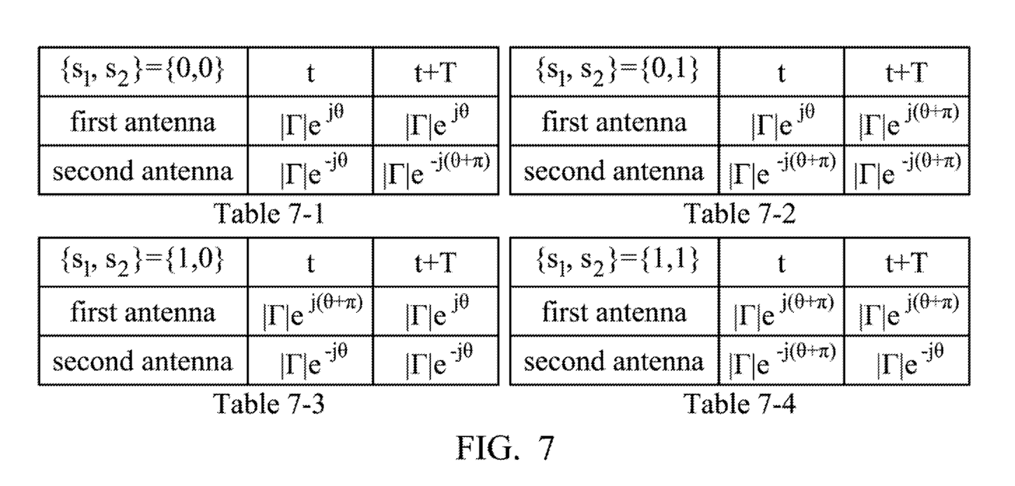

In some embodiments, the first antenna can also transmits two kinds of signals, |Γ|l^{jθ} or |Γ|l^{j(θ+π)} according to the sub-tables 7-1˜7-4 in the FIG. 7, such that the space-time code encoding modulator 315 only generates two phases, in which |Γ| represents the absolute value of Γ, the phase difference between them is 180 degrees, and the load Z_{1,A1} of the backscatter signal S_{1,A1} (corresponding to the signal |Γ|l^{j(θ+π)}) and the load Z_{2,A1} of the backscatter signal S_{1,A1} (corresponding to the signal |Γ|l^{jθ}) are the same. Furthermore, the second antenna only transmits two kinds of signal, |Γ|l^{-jθ} or |Γ|l^{j(θ+π)} such that the space-time code encoding modulator 315 only generates two phases, in which the phase difference between them is 180 degrees, and the load Z_{1,A2} of the backscatter signal S_{1,A2} (corresponding to the signal |Γ|l^{j(θ+π)}) and the load Z_{2,A2} of the backscatter signal S_{2,A2} (corresponding to the signal |Γ|l^{-jθ}) are the same.

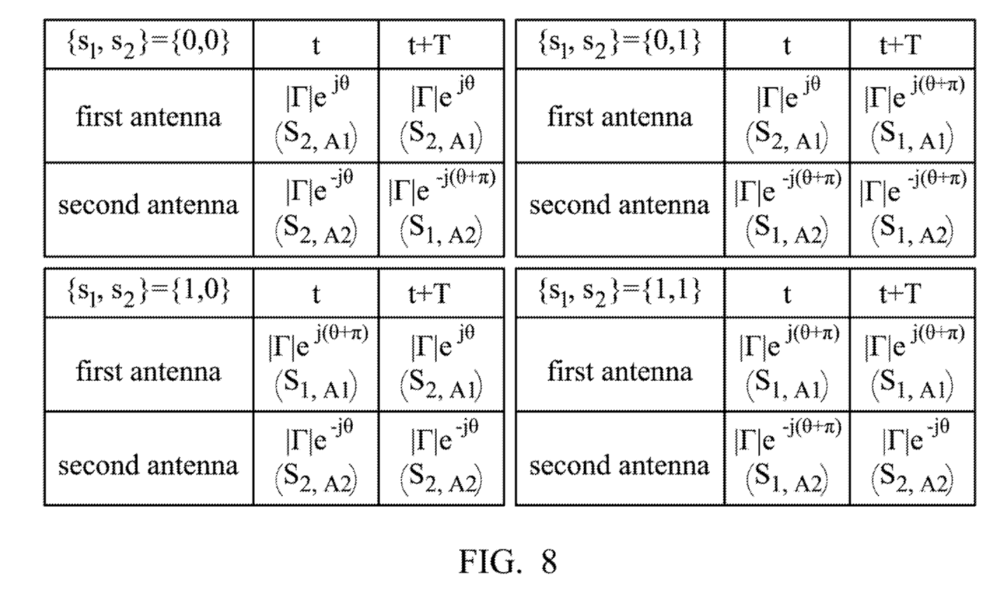

Therefore, the space-time code encoding modulator 315 only controls the first antenna to switch between the load Z_{1,A1} and the load Z_{2,A1} and the second antenna to switch between the load Z_{1,A2} and the load Z_{2,A2} according to the description above. For example, the space-time code encoding modulator 315 controls the first antenna to switch to the load Z_{1,A1} when the first antenna wants to transmit the signal |Γ|l^{j(θ+π)}, and then the signal is immediately sent by the first antenna is |Γ|l^{j(θ+π)}. Furthermore, the space-time code encoding modulator 315 controls the first antenna to switch to the load Z_{2,A1} when the first antenna wants to transmit the signal |Γ|l^{jθ}, and then the signal is immediately sent by the first antenna is |Γ|l^{jθ}. In addition, the space-time code encoding modulator 315 controls the second antenna to switch to the load Z_{1,A2} when the second antenna wants to transmit the signal |Γ|l^{j(θ+π)}, and then the signal is immediately sent by the second antenna is |Γ|l^{j(θ+π)}. Furthermore, the space-time code encoding modulator 315 controls the second antenna to switch to the load Z_{2,A2} when the second antenna wants to transmit the signal and then the signal is immediately sent by the second antenna is |Γ|l^{-jθ}. Therefore, FIG. 8 is a table illustrating the transmitted backscatter signals corresponding to the sub-tables 7-1˜7-4 according to an embodiment of the invention. Obviously, FIG. 7 illustrates a general example of backscatter signal constellation for various |Γ| and θ, and the example shown in FIG. 5 is a specific example which |Γ| is 1 and θ is 45 degrees of the shown in FIG. 7.

With the example and explanations above, the features and spirit of the invention are hopefully well described. Those skilled in the art will readily observe that numerous modifications and alterations of the embodiments may be made while retaining the teachings of the invention. Accordingly, the above disclosure should be construed as limited only by the metes and bounds of the appended claims.

What is claimed is:

1. A radio frequency identification tag for multi-path transmission, comprising:
a plurality of antennas, receiving a wireless signal transmitted by a reader and generating an antenna signal, respectively, and backscattering an encoded and modulated backscatter signal to the reader, in which the polarizations of the plurality of antennas are different;
a demodulator, demodulating the antenna signal, to generate a plurality of demodulated signals corresponding to the antenna signal;
a signal processor, selecting one of the plurality of demodulated signals or combining the plurality of demodulated signals for processing according to characteristics of the plurality of the demodulated signals to read data and generating a backscatter signal; and
a space-time code encoding modulator, encoding and modulating the backscatter signal according to a space-time code to generate the encoded and modulated backscatter signal.

2. The radio frequency identification tag of claim 1, wherein the polarizations of the plurality of antennas are mutually orthogonal.

3. The radio frequency identification tag of claim 1, wherein the space-time code is selected from the group consisting of space-time black code (STBC) and space-time trellis code (STTC).

4. The radio frequency identification tag of claim 1, wherein the characteristics of the plurality of the demodulated signals comprise signal power and signal quality.

5. The radio frequency identification tag of claim 1, wherein the demodulator down converts the antenna signal to a baseband signal.

6. The radio frequency identification tag of claim 1, wherein the demodulator further converts the antenna signal in analog to a digital signal.

7. The radio frequency identification tag of claim 1, wherein the plurality of antennas comprises a first antenna and a second antenna, and the polarizations of the first antenna and the second antenna are mutually orthogonal.

8. The radio frequency identification tag of claim 1, wherein the demodulator comprises a first sub-demodulator and a second sub-demodulator, and the first sub-demodulator and the second sub-demodulator demodulate the antenna signal, respectively, to generate the demodulated signals.

9. The radio frequency identification tag of claim 1, wherein the space-time code encoding modulator modulates the retransmission signal by backscatter.

10. The radio frequency identification tag of claim 1, further comprising a power harvester or a battery.

11. A radio frequency identification transmission method used for a radio frequency identification system, comprising:
receiving a wireless signal transmitted by a reader by a plurality of antennas and generating an antenna signal, respectively, in which the polarizations of the plurality of antennas are different;
demodulating the antenna signal, respectively, to generate a plurality of demodulated signals corresponding to the antenna signal;
selecting one of the plurality of demodulated signals or combining the plurality of demodulated signals for processing according to characteristics of the plurality of the demodulated signals to read data, and generating an backscatter signal;
encoding and modulating the backscatter signal according to a space-time code to generate the encoded and modulated backscatter signal; and backscattering the encoded and modulated backscatter signal to the reader, respectively, by the plurality of antennas.

12. The radio frequency identification transmission method of claim 11, wherein the polarizations of the plurality of antennas are mutually orthogonal.

13. The radio frequency identification transmission method of claim 11, wherein the space-time code is selected from the group consisting of space-time black code (STBC) and space-time trellis code (STTC).

14. The radio frequency identification transmission method of claim 11, wherein the characteristics of the plurality of the demodulated signals comprise signal power and signal quality.

15. The radio frequency identification transmission method of claim 11, wherein the demodulating step is by down converting the antenna signal to a baseband signal.

16. The radio frequency identification transmission method of claim 11, wherein the demodulating step further comprises converting the antenna signal in analog to a digital signal.

17. The radio frequency identification transmission method of claim 11, wherein the plurality of antennas comprises a first antenna and a second antenna, and the polarizations of the first antenna and the second antenna are mutually orthogonal.

18. The radio frequency identification transmission method of claim 11, wherein the encoding and modulating step comprises modulating the retransmission signal by backscatter.

19. A reader for transmitting a wireless signal to said radio frequency identification tag as claimed in claim 1, comprising:
a read antenna, receiving the encoded and modulated backscatter signal transmitted, respectively, by the plurality of antennas;
a channel estimator, estimating a plurality of channel information according to the encoded and modulated backscatter signal; and
a maximum ratio combining device, processing the encoded and modulated backscatter signal according to the encoded and modulated backscatter signal and the plurality of channel information.
